(19) United States
(12) Patent Application Publication
(10) Pub. No.: US 2026/0348342 A1
(43) Pub. Date: Nov. 5, 2026

(54) PRESSURE REGULATOR UNIT FOR HYDROGEN ENGINE

(71) Applicant: PHINIA DELPHI LUXEMBOURG SARL, Belvaux (LU)

(72) Inventors: Philippe LEGRAND, St. Gervais la Foret (FR); Christophe TAPIN, Saint Sulpice de Pommeray (FR)

(21) Appl. No.: 19/106,429

(22) PCT Filed: Jul. 27, 2023
(86) PCT No.: PCT/EP2023/070897

§ 371 Date: Feb. 25, 2025

(30) Foreign Application Priority Data
Aug. 30, 2022 (GB) 2212557.9

(51) Int. Cl. F02M 21/02

(52) U.S. Cl. CPC F02M 21/0239; F02M 21/0242

(57) ABSTRACT

A pressure regulator unit for regulating the pressure of a high-pressure gaseous fuel stream includes a regulator body with a gas passage extending between an inlet section for receiving the gaseous fuel at a high pressure and an outlet section. A regulating valve seat surrounds the gas passage and cooperates with a regulating valve element. A reciprocally arranged pintle permits actuating the regulating valve element relative to the regulating valve seat. A shut-off valve seat surrounds the passage and cooperates with a shut-off valve element actuatable by the reciprocating pintle. The regulating and shut-off valve seats are axially spaced from each other along the gas passage. The shut-off valve member is moveable on an upstream side of the shut-off valve seat to be biased by high pressure gaseous fuel in its closed position. The regulating valve member is arranged on a downstream side of its respective regulating valve seat.

### FIELD OF THE INVENTION

The present invention generally relates to fuel injection systems for gaseous fuels and in particular to a pressure regulator unit for regulating the pressure of high-pressure gaseous fuel in an internal combustion engine.

### BACKGROUND OF THE INVENTION

Many stationary and mobile internal combustion engines (ICE) utilize a compressed gas as a gaseous fuel which, when mixed with air provides the energy to power the engine. The gaseous fuel, e.g. compressed natural gas (CNG) or hydrogen, is generally stored in a tank under high pressure which pressure may be, for example, in the order of about 700 bar. Such high pressure is not generally compatible with the operation of an internal combustion engine. Accordingly, the gas pressure must be reduced to a level acceptable for introduction into the ICE. The pressure level of the CNG for introduction into the ICE may be in the range of 2 bar to 10 bar and up to 40 bar for hydrogen ICE. A pressure regulator is therefore installed between the fuel tank G and the fuel rail/injectors to provide the desired reduction in pressure of the gaseous fuel.

Many pressure regulator applications have heretofore utilized a mechanical pressure regulator to provide the reduction in gas pressure by utilization of a combination of valves, diaphragms and/or pistons, springs and other mechanical devices to provide the reduction in the gas pressure.

Also known are electronically controlled gas pressure regulator. However most electronic gas pressure regulators known for CNG applications can only operate at pressure up to 16 bar, making them unsuitable for hydrogen engines which operate at higher pressures, typically between 40 and 20 bar. Moreover, typical pressure regulators available today have a certain leak when closed and an additional shut-off valve therefore needs to be installed in the system. The shut-off valve must be closed when the engine is stopped and opens when it runs.

### OBJECT OF THE INVENTION

The object of the present invention is to provide a pressure regulator unit of improved design.

### SUMMARY OF THE INVENTION

The present invention relates to a pressure regulator unit for regulating the pressure of a high-pressure gaseous fuel stream comprising:
a regulator body with a gas passage extending between an inlet section for receiving the gaseous fuel at a high pressure and an outlet section;
a regulating valve seat surrounding said gas passage and cooperating with a regulating valve element, said regulating valve element being moveable between a closed position in which said regulating valve element is applied onto said regulating valve seat preventing flow of gaseous fuel therethrough, and one or more open positions off said regulating valve seat;
a reciprocally arranged pintle for actuating said regulating valve element relative to said regulating valve seat;
a shut-off valve seat surrounding said passage, cooperating with a shut-off valve element actuatable by said reciprocating pintle, said shut-off valve element being moveable between a closed position, on said shut-off valve seat, and an open position off said shut-off valve seat;
wherein said regulating and shut-off valve seats are axially spaced from each other along said gas passage;
wherein said shut-off valve member is moveable on an upstream side of said shut-off valve seat to be biased by high pressure gaseous fuel in its closed position;
wherein said regulating valve member is arranged on a downstream side of its respective regulating valve seat.

The present pressure regulator unit is designed as a self-contained unit (or module/component) that integrates both a shut-off function and a pressure regulator function. This is achieved by the use of a shut-off valve seat and regulating valve seat in the passage defined by the regulator body, in cooperation with the shut-off and regulating valve elements. Both valve elements are supported and actuated by the pintle. The combination of the shut-off and regulating functions in a single unit reduces the diversity of parts and the manufacturing requirements. This brings a reduction of costs, requires less connections and reduces related risks.

It will also be appreciated that due to the arrangement of the shut-off valve member upstream of its valve seat, the high pressure tends to maintain the shut off valve member in closed position when no actuating force is applied to the pintle. That is, the present pressure regulator unit is, by design, closed by default, providing enhanced safety.

The pressure regulation function is achieved by moving the regulating valve element relative to the regulating valve seat, by actuation of the pintle, in order to selectively adjust the distance between the latter and hence define different flow cross-sections or close the regulating valve seat.

Due to the design of the pressure regulator unit, to enter the regulation mode it is necessary to move the pintle in counter flow direction, which will necessarily imply that the shut-off valve seat is open.

In embodiments, the shut-off valve member and/or the regulating valve member define a spherical or frusto-conical annular sealing surface that cooperates with an annular sealing surface defined by the shut-off valve seat and regulating valve seat, respectively.

Advantageously, the annular sealing surface of the shut-off valve member and/or the annular sealing surface of the regulating valve member is coated with a resilient polymer, e.g. an elastomer. For example, the shut-off valve member and/or regulating valve member may be made of metal, and the part that defines the annular sealing surface (at least), is coated with the polymer/elastomer. Alternatively, the valve member itself (or the part defining the sealing surface) may be made from the resilient polymer/elastomer. The use of resilient polymer surfaces is considered useful to improve the gas sealing in the context of hydrogen fuel. The elastomer may e.g. be selected from the EPDM rubber family, or similar.

In embodiments, the shut-off valve seat is located upstream of the regulating valve seat.

In embodiments, the regulating valve member is formed as a sleeve member fitted over the pintle, the annular sealing surface being arranged at an end of the sleeve member proximal the shut-off valve seat, the sleeve member being axially fixed relative to said pintle.

For example, the sleeve member may be made from resilient polymer material (e.g. elastomer). A guide sleeve may be fitted over the pintle and partially covers the sleeve member on the side opposite its annular sealing surface, the guide sleeve extending axially up to a rear end of the pintle.

In embodiments, the shut-off valve member is shaped as a ball or comprises a frusto-conical plug member. Either way, the valve member is designed to cooperate with the shut off valve seat. The ball, respectively the plug member, may be metallic and coated with the resilient polymer (elastomer or the like).

In embodiments, the shut-off valve member is elastically biased towards the closed position.

In embodiments, the shut-off valve seat opens in an upstream chamber in which the shut-off valve element is moveable, and a spring is arranged in the chamber with an end thereof bearing against the shut-off valve element to push the latter in closing direction. In such embodiment, an insert comprising a tubular wall defining a passageway from said inlet section towards said shut-off valve seat may be screwed in the chamber, the passageway having a downstream section in which the shut-off valve element is axially guided. The spring may be arranged in the passageway with a second end in abutment against an annular shoulder; and a clearance being formed around the downstream portion of the insert and the chamber, whereas one or more channels extend through the tubular wall to connect the passageway with the clearance.

Actuation of the pressure regulator unit may conveniently be carried out with an electromechanical actuator having an actuating stem that, when selectively energized, is moved to act upon the pintle in order to displace it axially in counterflow direction.

According to another aspect, the invention relates to a fuel control module comprising a pressure regulator unit as disclosed herein.

### BRIEF DESCRIPTION OF THE DRAWINGS

The present invention will now be described, by way of example, with reference to the accompanying drawings, in which:

FIG. 1: is a cross-sectional view through an embodiment of the present pressure regulator unit, in shut-off configuration;

FIG. 2: is a cross-sectional view through the pressure regulator unit of FIG. 1, in regulation mode; and

FIG. 3: is a cross-sectional view through the pressure regulator unit of FIG. 1, with the regulator closed.

### DETAILED DESCRIPTION OF PREFERRED EMBODIMENTS

An embodiment of the inventive pressure regulator unit 10 for high-pressure gaseous fuel is described below. The present pressure regulator unit 10 has been developed for hydrogen engines, although it may be used with other gaseous fuels, e.g. CNG or fuel cell gas.

The pressure regulator unit 10 is designed as a unit or module that is typically integrated into a support or a fuel module. Such support may be composed of a metal bloc 2 (partly shown) that comprises a cylindrical recess 3 for receiving a unit having a generally cylindrical outer shape as for the present regulator unit 10.

The pressure regulator unit 10 comprises a body 12 with a gas passage 13 extending between an inlet section 14 for receiving the gaseous fuel at a high pressure and an outlet section 16 from which the gaseous fuel is discharged. The gas inlet 14 is in communication with a high-pressure fuel tank system (not shown) and the gaseous fuel is discharged through the outlet section 16 towards a fuel rail assembly (not shown) at around 20 to 40 bar depending on the application. High pressure gas arrives at inlet section 14 through a channel 4 in the fuel support bloc 2. On the outlet side the discharged fuel flows through another channel 5 in bloc 2. The bloc/support will comprise the required connectors/fittings for connection in the fuel delivery system. In alternative embodiments (not shown), the pressure regulator unit 10 may be provided with connectors or fittings, as required.

The body 12 is made out of metal, e.g. stainless steel, and has a generally cylindrical shape extending along an axis A, whereby the body 12 has a first end 12.1, a second end 12.2 and a side 12.3. The inlet section 14 is located at the first end 12.1 of the body 12, from which the passage 13 defines a high-pressure section or chamber 18, followed by a control section 20, and then the outlet section 16.

In the present embodiment, the high-pressure chamber 18 has a broad cross-section, and the control section 20, axially opposite the inlet section 14, has a comparatively narrower flow cross-section. The control section 20 opens here directly into the outlet section 16, which is formed as a transversal channel (relative to axis A, namely perpendicular), whereby the pressure regulator unit here comprises two outlet ports 16.1 and 16.2.

As can be seen, the body 12 of the pressure regulator unit 10 fits into the recess in bloc 2. An annular groove 22 in side 12.3 is provided with an annular seal 24 to seal off the inlet side. Towards the second end 12.2, the annular body 12 is further provided with an annular recess 26 in which both outlet ports 16.1 and 16.2 open. This provides an annular outlet space for the gaseous fuel, avoiding indexing/orientation issues when inserting the pressure regulator unit 10 in recess 3.

The present pressure regulator unit 10 is designed to combine the functions of pressure regulator and shut off valve. To achieve this dual function, it includes a couple of valve seats with associated valve members.

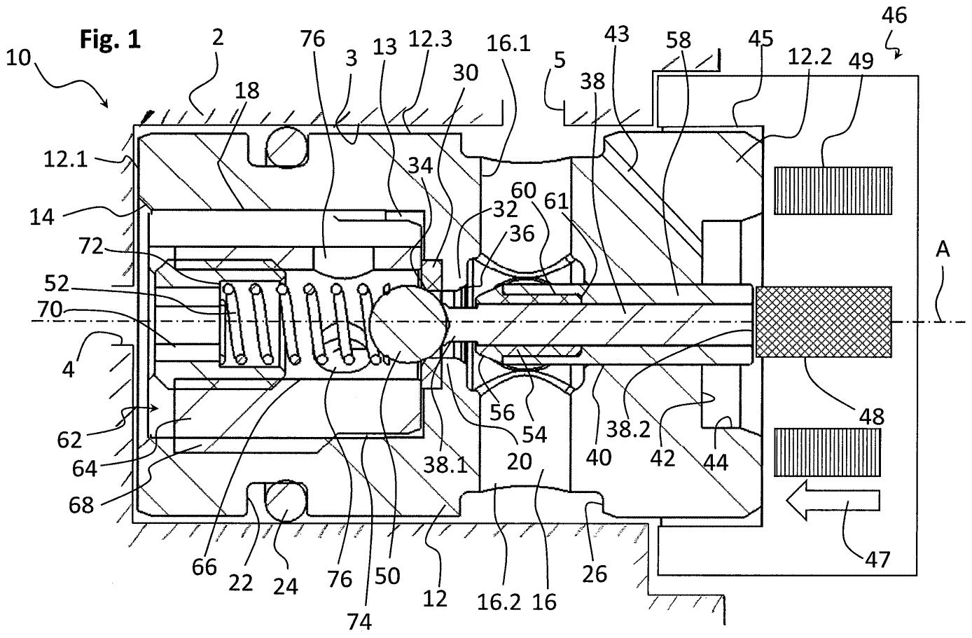

As shown in FIG. 1, the control section 20 includes a couple of valve seats 30, 32 that surround the passage 13 and through which the entire gaseous flow circulates when not obturated.

The first valve seat 30, referred to as shut-off valve seat, is positioned at the interface with the high-pressure chamber 18. Shut-off valve seat 30 defines an annular sealing surface 34 turned towards high-pressure chamber 18.

The second valve seat 32, referred to as regulating valve seat, is located, in flow direction, after the shut-off valve seat 30 and is thus axially spaced therefrom. The regulating valve seat 32 has an annular sealing surface 36 that is oriented opposite that of the shut-off valve seat 30.

The two valve seats 30, 32 cooperate with respective valve elements in order to control the flow through the valve seats. The two valve elements are moveable by means of a pintle 38 that is reciprocally moveable in body 12 along axis A.

The pintle 38 is introduced into body 12 from the left side 12.1, through chamber 18, and comprises a first end 38.1 inside the HP chamber 18 and an opposite second end 38.2. The pintle 38 is axially guided in an axial bore 40 arranged beyond the outlet section 16. For the purpose of actuation, the second end 38.2 of the pintle protrudes from an end surface 42 of the body, e.g. located in a recess 44 in the end face 12.2. There, the pintle 38 can be actuated upon by an actuator 46 only schematically shown in the FIG. 1, and fixed to body 12 at its second end 12.2. The actuator 46 may of the electromechanical type, e.g. a solenoid actuator. The actuator 46 has an actuating stem 48 (associated with a mobile armature—not shown) that can be moved to exert a force on the pintle 38. Actuator 46 includes a solenoid 49 that generates, when energized, a magnetic field capable of moving the stem 48 (via the armature) in the actuating direction indicated by arrow 47.

In this embodiment, the second end 12.2 of body 12 is received in a recess 45 of actuator 46. Actuator 46 may be partly received in a stepped inlet portion of recess 3. A seal ring may be arranged around the actuator in the stepped inlet portion for sealing purposes.

A return channel 43 may be provided to connect end recess 44 to the outlet 16, to allow return of gaseous fuel having made its way to actuating region.

The pressure regulating unit 10 may be fixed to its support by means of any appropriate mechanical assembly, e.g. flanged, clamped, press fitted, screwed, or by means of a bayonet. In particular, the pressure regulating unit 10 may be fixed e.g. by means of a screwed flange radially extending either from body 12 at the second end 12.2 or extending from the actuator assembly.

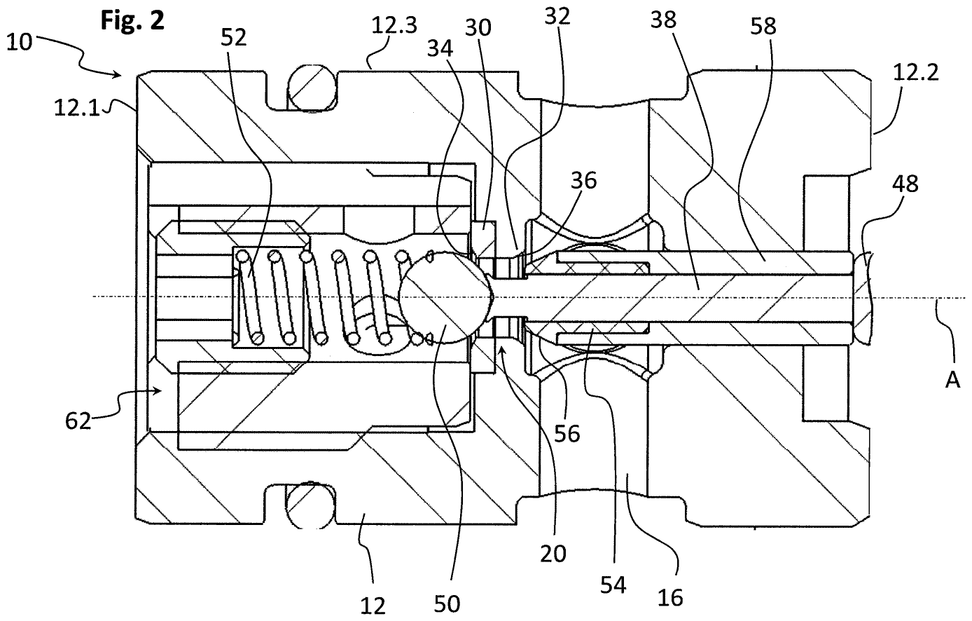

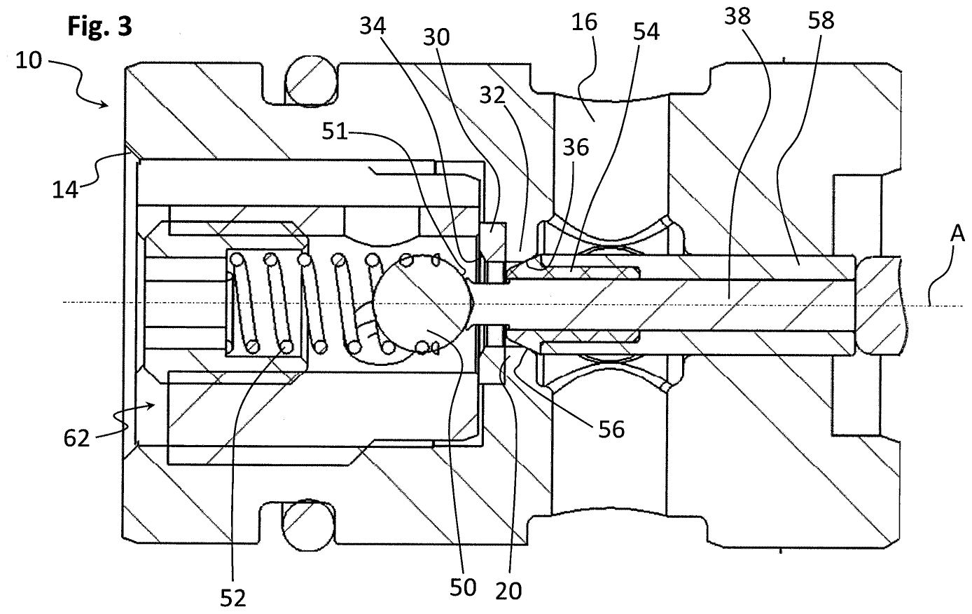

Reference sign 50 indicates the shut-off valve element cooperating with the shut-off valve seat 30. The shut-off valve element 50 generally has a cross section larger than the flow aperture through the shut-off valve seat 30. The first valve element 50 here takes the form of a ball that is integral with the pintle 38. Ball 50 can be fixed (welded) to the pintle 38, as is the case here, or formed in one piece therewith. In FIG. 1, the first valve element 50 rests on the shut-off valve seat 30, which is thus closed (i.e. this is the closed position of the shut-off function). In FIGS. 2 and 3, the first valve element 50 is spaced from the shut-off valve seat 30, allowing flow therethrough.

The shut-off valve member 50 is preferably a metal (stainless steel) ball coated with a layer of resilient polymer, in particular an elastomer or the like. In the case of this ball-shaped member 50, the whole exposed surface of the ball can be coated with the elastomer. In any case at least the part thereof that contacts the seat 30, i.e. the annular sealing surface 51 of ball 50, is coated with elastomer.

The valve member 50 is biased by a spring 52 towards the shut off seat 30. Here the ball 50 is directly biased by spring 52 but in other embodiments spring means can be arranged for indirect biasing, e.g. to act on the pintle 38. In use, the high pressure (HP) arriving from the inlet section 14 also tends to bias the shut-off valve member 50 onto its seat. When the shut-off valve member 50 is on the seat 30, i.e. in closed position, it rests onto the annular seat surface 34 and obturates, in a fluid tight manner, the flow of gaseous fuel through the seat 30. Such closed position is the default position of the pressure regulator unit 10, when the actuator 46 is not energized.

As will be understood, the shut-off valve member 50 can only be brought in an open position, such as shown in FIGS. 2 and 3, by operating (energizing) the actuator 46 to move the actuator stem 48 in an outward position, namely to the left on the figure, which is also a counter-stream direction along axis A. Conversely, de-energizing the actuator 46 would stop the magnetic field and the force applied by stem 48, whereby the spring 52 would push the ball 50 towards the shut-off valve seat 30 to close the latter and the pintle 38 would simultaneously move to the right (from a position as in FIG. 2 or 3).

Reference sign 54 indicates the regulating valve element that cooperates with the regulating valve seat 32. Regulating valve element 54 is arranged on the downstream side of the respective seat 32. As for ball 50 (the shut-off valve element), regulating valve element 54 is supported by the pintle 38: it takes the form of an annular sleeve tightly surrounding the pintle 38 that comprises an annular sealing surface 56 configured to cooperate with the regulating valve seat 32. Annular sealing surface 56 is formed as a slanted surface, e.g. frusto-conical, at the sleeve end proximal to the regulating valve seat 32.

In the embodiment, sleeve-shaped regulating valve element 54 is made out of resilient polymer, in particular an elastomer (e.g. an elastomer such as EPDM or the like) and preferably fitted over the pintle 38 with a tight clearance (interference fit). A guide sleeve 58 coaxially surrounds the pintle 38 and comprises a stepped end section 60 proximal the regulating valve element 54, which thus overlaps and covers the element 54. Valve element 54 rests against a shoulder 61 of the stepped section 60; and the guide sleeve 58 extends up to the second end 38.2 of the pintle. During actuation, the actuating force is applied by stem 48 onto both the pintle 38.2 and guide sleeve 58, so that they move together as a single pintle assembly. These constructional measures ensure a fixed support position for the regulating valve element 54 and thus ensures a fixed position of the regulating valve element 54 on the pintle 38.

Furthermore, whereas the guide sleeve 58 may be arranged with a free fit over pintle 38, the use of the polymer valve member 54 (annular sleeve) tightly surrounds pintle 38 and hence provides a fluid tight sealing of the pintle assembly.

In other embodiments (not shown), the valve element 54 may be metallic and integral with guide sleeve 58. In such case the metallic valve element with the annular sealing surface is preferably provided with a resilient polymer/elastomer coating.

In FIG. 1, the regulating valve element 54 is spaced from its regulating valve seat 32, however the shut-off function is closed. No fuel can flow towards regulating valve seat 32. In FIG. 3, the regulating valve element 54 is applied by the actuator 46 onto the regulating valve seat 32. This is the closed position of the pressure regulating function, in which the regulating valve element 54 obturates the flow of gaseous fuel through the regulating valve seat 32.

It may be noted that, in the shown embodiment, the distance between the two valve members is greater than the distance between the two valve seat seats. The distance between valve members 30, 32 is adapted by design depending on the desired stroke to achieve the desired throttling in the pressure regulation mode.

Conventionally, the magnetic force created by the actuator 46 is controlled through the applied current, which is in turn controlled by a controller, e.g. ECU. That is the controller is capable of precisely controlling the outward movement of the pintle, over different stroke lengths.

Regulation of the pressure downstream of the regulating valve seat 32 is achieved by selectively opening and closing the seat 32 by means of the regulating valve element 54 (controlled via actuator 46).

As will be understood, in the closed position of the shut-off element 50 (FIG. 1), the regulating valve element 54 is spaced from the regulating valve seat 32. Hence, to regulate flow/pressure, the pintle 38 must be selectively moved toward the regulating valve seat 32 in counterflow direction, which will necessarily cause opening of the shut-off valve.

In the shown embodiment, shut-off valve element 50 is axially guided by an insert member 62 in the HP chamber 18. Insert member 62 has a tubular wall 64 that defines a passage 66 which is axially open toward the inlet section 14 and the shut off valve seat 30. Tubular wall 64 is provided with an outer threaded section 64 by which it is screwed on a corresponding thread in HP chamber 18. The downstream end of passage 66 is configured to received valve element 50 in a guided manner, with a sliding clearance. Spring 52 is also arranged in passage 66 and maintained therein by a hollow screw 70. Screw 70 is formed as a sleeve member having an outer thread cooperating with a threaded section on the inlet side of passage 66. Spring 52 is partially received in screw 70 and is in abutment against an annular shoulder 72 on the inner periphery.

As can be seen, insert 62 is not in abutment with the end of the HP chamber. That is, an annular clearance 74 exists between the end portion of insert 62 proximal the shut-off valve seat 30 and the HP chamber 13 and a plurality of transverse channels 76 extend (radially) through the wall 64, arranged in-between the threaded section 68 and the portion of passage 66 receiving the valve element 50. These constructional measures allow gaseous fuel to flow from inside the insert 62 into the annular gap 74, in order to flow towards the shut-off valve seat 30.

To recap, the shut-off valve function is realized with a pintle 38 having a tip with a spherical (or alternatively conical) sealing surface, advantageously coated with an elastomer coating. The pintle tip is spring biased against the shut-off valve seat, fully closing the flow aperture therethrough. The Pressure regulator is closed when the actuator is not energized (i.e. closed by default).

To exit the shut-off mode and enter the regulation mode, a high current pulse is applied to the actuator solenoid and the magnetic force is high enough to move the pintle against the upstream pressure and spring. The mobile armature is applying a force through the magnetic circuit directly on the pintle.

Then once the pintle is away from the shut-off valve seat, the flow will pass toward the downstream volume and the downstream pressure will start to rise.

In the regulation mode, the magnetic force is controlled through the applied current from the ECU or other controller. The regulation sleeve 54 ended by the elastomer regulating valve element 56 will be moved relative to the regulating valve seat 32, hence controlling the distance and thus the flow section. Such regulating position is illustrated in FIG. 2: the shut off valve 50 is in open position and the regulating valve member 56 is at a controlled distance from the regulating seat 36. In the outermost pintle position, the regulating valve seat 36 is closed (typically with very small leak lower than idle required flow).

In case of solenoid failure or loss of driving circuit and current, the pressure regulator unit 10 will close in shut off mode.

In case of failure of upstream static pressure, the pressure regulator unit will also close and the excess pressure will help to seal the shut-off valve member on its seat before the pressure relief valve will enter in action.

1. A pressure regulator unit for regulating the pressure of a high-pressure gaseous fuel stream, the pressure regulator unit comprising:
a regulator body with a gas passage extending between an inlet section for receiving the gaseous fuel at a high pressure and an outlet section
a regulating valve seat surrounding said gas passage and cooperating with a regulating valve element said regulating valve element being moveable between a closed position in which said regulating valve element is applied onto said regulating valve seat preventing flow of gaseous fuel therethrough, and one or more open positions off said regulating valve seat;
a reciprocally arranged pintle for actuating said regulating valve element relative to said regulating valve seat;
a shut-off valve seat surrounding said passage, cooperating with a shut-off valve element actuatable by said reciprocating pintle, said shut-off valve element being moveable between a closed position, on said shut-off valve seat, and an open position off said shut-off valve seat;
wherein said regulating and shut-off valve seats are axially spaced from each other along said gas passage;
wherein said shut-off valve member is moveable on an upstream side of said shut-off valve seat to be biased by high pressure gaseous fuel in its closed position;
wherein said regulating valve member is arranged on a downstream side of its respective regulating valve seat

2. The pressure regulator unit according to claim 1, wherein said shut-off valve member and/or said regulating valve member define a spherical or frusto-conical annular sealing surface that cooperates with an annular sealing surface defined by the shut-off valve seat and regulating valve seat, respectively.

3. The pressure regulator unit according to claim 1, wherein said annular sealing surface of said shut-off valve member and/or said annular sealing surface of said regulating valve member is part of a member made from, or coated with, a resilient polymer, in particular an elastomer.

4. The pressure regulator unit according to claim 1, wherein the shut-off valve seat is located upstream of said regulating valve seat

5. The pressure regulator unit according to claim 2, wherein said regulating valve member is formed as a sleeve member fitted over said pintle, the annular sealing surface being arranged at an end of said sleeve member proximal said shut-off valve seat, said sleeve member being axially fixed relative to said pintle.

6. The pressure regulator unit according to claim 5, wherein said sleeve member is made from resilient polymer material and a guide sleeve is fitted over said pintle and partially covers said sleeve member on the side opposite its annular sealing surface, said guide sleeve extending axially up to a rear end of said pintle.

7. The pressure regulator unit according to claim 1, wherein said shut-off valve member is shaped as a ball or comprises a frusto-conical plug member,

8. The pressure regulator unit according to claim 1, wherein said shut-off valve member is elastically biased towards the closed position.

9. The pressure regulator unit according to claim 1, wherein said shut-off valve seat opens in an upstream chamber in which said shut-off valve element is moveable, and
a spring is arranged in said chamber with an end thereof bearing against said shut-off valve element to push the latter in closing direction.

10. The pressure regulator unit according to claim 9, wherein
an insert comprising a tubular wall defining a passageway from said inlet section towards said shut-off valve seat is screwed in said chamber, said passageway having a downstream section in which said shut-off valve element is axially guided;
said spring is arranged in said passageway with a second end in abutment against an annular shoulder;
a clearance is formed around the downstream portion of said insert and the chamber, whereas one or more channels extend through the tubular wall to connect the passageway with the clearance.

11. The pressure regulator unit according to claim 1, further comprising an electromechanical actuator having an actuating stem that, when selectively energized, is moved to act upon said pintle in order to displace it axially in a counterflow direction.

12. A fuel control module comprising a pressure regulator unit according to claim 1.
